(19) United States
(12) Patent Application Publication
(10) Pub. No.: US 2010/0223050 A1
(43) Pub. Date: Sep. 2, 2010

(54) METHOD AND SYSTEM FOR EVALUATING A CONDITION ASSOCIATED WITH A PERSON

(75) Inventor: Ken Kelly, Frisco, TX (US)

Correspondence Address: OSHA LIANG L.L.P., TWO HOUSTON CENTER, 909 FANNIN, SUITE 3500, HOUSTON, TX, 77010, US

(73) Assignee: KEN KELLY, Frisco, TX (US)

(21) Appl. No.: 12/395,460

(22) Filed: Feb. 27, 2009

(51) Int. Cl. G06F 17/20

(52) U.S. Cl. 704/8

(57) ABSTRACT

A computer readable medium including computer executable instructions for evaluating a condition associated with a first person. The instructions include functionality to present a first question in a first language, receive a selection of the first question, and obtain a first audio file corresponding to the first question in a second language. The instructions further include functionality to output the first question in the second language using the first audio file and present a first number of answers to the first question, where the first number of answers is in the first language. The instructions further include functionality to receive a selection of one of the first number of answers, perform an evaluation of the condition associated with the first person based on the selection of the first question and the selection of the one of the first number of answers, and present the evaluation to the user.

### BACKGROUND

Various situations in life present themselves where two or more people, each speaking a different language that is not understood by the other, must be able to communicate. This is especially true where one of the people is working in a professional capacity. For example, emergency medical technicians and airport security personnel working at international airports often encounter people who do not communicate in the language of the professional and who communicate in a language that is not understood by the professional.

In cases such as these, time may be of the essence for the professional to receive information needed to do her job. For example, an emergency caregiver, such as an emergency medical technician responding to a 9-1-1 emergency telephone call, must be able to quickly diagnose a patient with a medical emergency to determine how best to treat the condition causing the emergency until the patient can be taken to a hospital emergency room or some other place where doctors (or other medical professionals) can fully treat the condition. To perform her job efficiently and effectively, the emergency medical technician needs to be able to communicate with the patient. Likewise, similar circumstances may exist for a healthcare worker, such as a registered nurse, who needs to be able to communicate with a patient.

As another example, a security professional screening passengers at an international airport checkpoint needs to efficiently deal with travelers to avoid unnecessary delays for the passengers waiting in line to be screened. The security professional needs to quickly understand whether the traveler she is screening is no threat to security or whether the traveler needs further screening away from the other travelers waiting to be cleared through security. This process can be difficult at locations with many international departures or at other locations where numerous people speaking foreign languages are commonly present. Similar circumstances may exist for a professional (e.g., law enforcement, airline check-in, cruise ship check-in, customs) working at a location with international departures and/or arrivals (e.g., airport, train station, shipping port, bus station, international checkpoint).

### SUMMARY

In general, in one aspect, the invention relates to a computer readable medium including computer executable instructions for evaluating a condition associated with a first person. The instructions for evaluating the condition associated with the first person include functionality to present a first question in a first language to a user, receive a selection of the first question from the user, and obtain a first audio file corresponding to the first question in a second language, where the first person communicates in the second language. The instructions for evaluating the condition associated with the first person further include functionality to output, in auditory form, the first question in the second language using the first audio file and present a first number of answers to the first question to the user, where the first number of answers is in the first language. The instructions for evaluating the condition associated with the first person further include functionality to receive a selection of one of the first number of answers from the user based on a response to the first question by the first person, perform an evaluation of the condition associated with the first person based on the selection of the first question and the selection of the one of the first number of answers, and present the evaluation to the user.

In general, in one aspect, the invention relates to a method for evaluating a condition associated with a first person. The method includes presenting a first question in a first language to a user, receiving a selection of the first question from the user, and obtaining a first audio file corresponding to the first question in a second language. The method further includes outputting, in auditory form, the first question in the second language using the first audio file and presenting a first number of answers to the first question to the user, where the first number of answers is in the first language. The method further includes receiving a selection of one of the first number of answers from the user based on a response to the first question by the first person, performing an evaluation of the condition associated with the first person based on the selection of the first question and the selection of the one of the first number of answers, and presenting the evaluation to the user.

In general, in one aspect, the invention relates to a communication device for evaluating a condition associated with a first person for a user. The communication device includes a processor, a speaker configured to output sounds, and a storage repository. The communication device also includes a memory including software instructions which, when executed by the processor, enable the communication device to present a first question in a first language on a display device to a user, receive a selection to the first question from the user, obtain from the storage repository a first audio file corresponding to the first question in the second language, output the first question in the second language using the speaker and the first audio file, present a first number of answers to the first question to the user, where the first number of answers is in the first language, receive a selection of one of the first number of answers from the user based on a response to the first question by the first person, perform an evaluation of the condition associated with the first person based on the selection of the first question and the one of the first number of answers, present the evaluation to the user using the display device, and store the evaluation in the storage repository.

Other aspects of the invention will be apparent from the following description and the appended claims.

### BRIEF DESCRIPTION OF DRAWINGS

FIG. 1 shows a diagram of a system in accordance with one or more embodiments of the invention.

FIG. 2 shows a diagram of a communication device in accordance with one or more embodiments of the invention.

FIG. 3. shows a flowchart of a method for evaluating a condition associated with a person in accordance with one or more embodiments of the invention.

FIG. 4 shows an example of obtaining a second language in accordance with one or more embodiments of the invention.

FIG. 5 shows an example of a question display screen in accordance with one or more embodiments of the invention.

FIG. 6 shows an example of an answer display screen in accordance with one or more embodiments of the invention.

FIGS. 7A and 7B illustrate various examples being performed by a system in which one or more embodiments of evaluating a condition associated with a person may be implemented.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for evaluating a condition associated with a person. More specifically, one or more embodiments of the invention provide a method and system for receiving information from a person speaking a foreign language in order to evaluate a situation involving the person speaking the foreign language. For convenience, throughout this specification, the person trying to ask the questions and receive information is the “user,” and the person being asked the questions and providing the information is the “subject.” For example, the subject may be a person in need of emergency medical attention, and the user may be an emergency medical technician. In another example, the subject is a traveler at a point of travel departure/arrival where the second language is not the native language of the traveler, and the user is a security screener or a member of law enforcement. Those skilled in the art will appreciate that the invention may generally apply to various applications and is not limited to medical emergency applications or to law enforcement applications.

The user may speak one language (i.e., a first language), and the subject may speak a different or foreign language (i.e., a second language). A language may include words, numbers, dialects, and other characteristics that contribute to a language spoken and understood by a group of people. In one or more embodiments of the invention, the first language and the second language are different languages. Further, in one or more embodiments of the invention, the user does not communicate in the second language, and the subject does not communicate in the first language. A language may be a general language (e.g., Spanish, English, German, Italian, French). A language may also be a version or variation within the general language (e.g., Spanish spoken in Spain versus Spanish spoken in Mexico; English spoken in New York City versus English spoken in Liverpool, England). A language may also be a regional variation of a broad language (e.g., Spanish in Mexico City, Spanish in Nuevo Laredo). A language may also be a means of communication that has evolved in a community or region (e.g., Creole or Cajun in Louisiana).

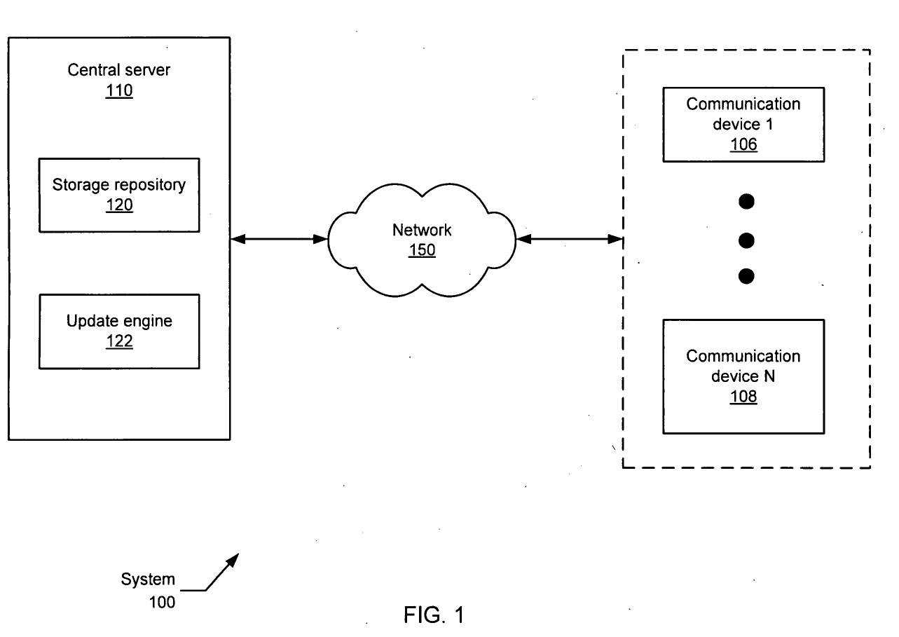

FIG. 1 shows a diagram of a system in accordance with one or more embodiments of the invention. The system (100) includes a central server (110), a network (150), and a communication device (e.g., communication device 1 (106), communication device N (108)). The central server (110) includes a storage repository (120) and an update engine (122). Each of these components is described below. One of ordinary skill in the art will appreciate that embodiments of the invention are not limited to the number or configuration of the components shown in FIG. 1.

In one embodiment of the invention, the central server (110) is configured to communicate with the communication device (e.g., communication device 1 (106), communication device N (108)) using the network (150) (e.g., a local area network (LAN), a wide area network (WAN), the Internet, a wired network, a wireless network, or any combination thereof) via a network interface connection (not shown). The central server (110) is also configured to host the storage repository (120) and the update engine (122).

In one embodiment of the invention, the storage repository (120) is a persistent storage device (or set of devices) and is configured to store information in a format(s) used by the communication device(s) (e.g., communication device 1 (110), communication device N (112)). Examples of a data structure stored by a storage repository (120) include, but are not limited to, a database, a spreadsheet, an extensible markup language (XML) document, and a plain text document. Examples of a storage repository (120) include a hard drive, a solid state drive, any other computer readable storage medium for storing data, or any combination thereof. The storage repository (120) may be distributed across multiple storage locations and/or support data stored in different formats. Examples of the information stored in the storage repository (120) include, but are not limited to, audio files(s) for a language, information related to a language (e.g., flag(s) of countries where the language is the native language), and localization components. In one or more embodiments of the invention, a localization component incorporates regulatory and/or social factors. For example, a localization component may be a protocol for evaluating a specific medical condition, as established by some authority such as an ambulance service, a government authority, a regulatory entity, or a professional group, such as the American Medical Association. As another example, a localization component may be personal information that must be collected from a patient. As yet another example, a localization component may be question and answer files of a particular dialect of a language that is spoken in a geographic area where the communication device is being used.

In one embodiment of the invention, the update engine (122) is configured to send the information stored in the storage repository (120) to the communication device(s) (e.g., communication device 1 (106), communication device N (108)) using the network (150). Further, the update engine (122) is configured to store one or more evaluations created by the communication device(s) (e.g., communication device 1 (106), communication device N (108)). The update engine (122) may send information in response to receiving a request. Alternatively, the update engine (122) may initiate the sending of information without receiving a request. For example, the update engine (122) may send information automatically when new information is entered into the storage repository (120) or at regularly scheduled intervals.

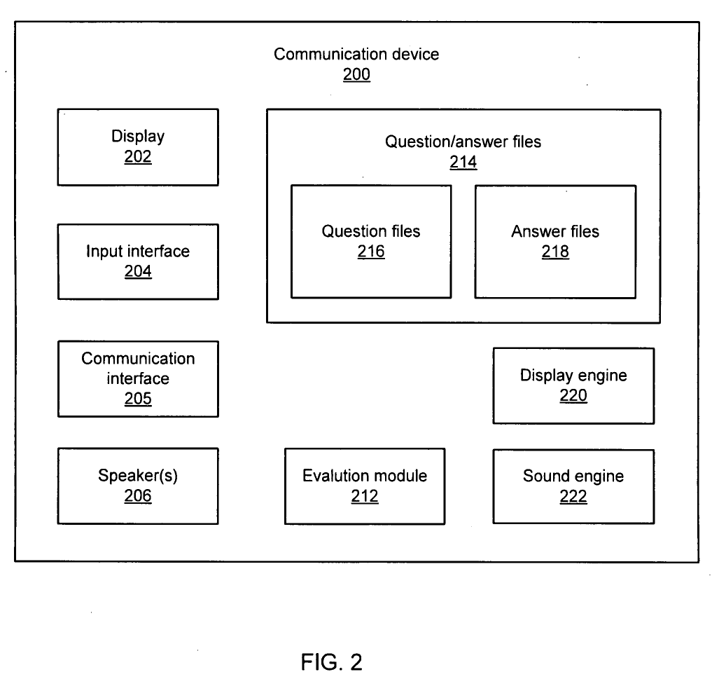

In one embodiment of the invention, the communication device(s) (e.g., communication device 1 (106), communication device N (108)) is configured to communicate over the network (150). The communication device(s) (e.g., communication device 1 (106), communication device N (108)) is described in more detail in FIG. 2 below.

FIG. 2 shows a diagram of a communication device in accordance with one or more embodiments of the invention. The communication device (200) includes output means (e.g., a display (202)), an input means (e.g., an input interface (204)), a communication interface (205), speaker(s) (206), a memory (not shown), a processor (not shown), an evaluation module (212), question/answer files (214), a display engine (220), a sound engine (222), and numerous other elements and functionalities typical of today's computing devices (not shown). The question/answer files (214) includes question files (216) and answer files (218). Each of these components is described below. Those skilled in the art will appreciate that the input and output means may take other forms, now known (e.g., a virtual keyboard) or later developed. One of ordinary skill in the art will appreciate that embodiments of the invention may be implemented on any type of computer regardless of the platform being used and are not limited to the configuration shown in FIG. 2. For example, the computing device (100) may be a computer system, a laptop, a media device (e.g., a portable television or DVD player, etc), a gaming device, a mobile phone (including a smart phone), a personal digital assistant, or any other suitable wired or wireless computing device. Generally speaking, the communication device (200) includes at least the minimal processing, input, and/or output means necessary to practice embodiments of the invention.

In one embodiment of the invention, the display (202) is a liquid crystal display (LCD). The display (202) may also be any other type of suitable interface for presenting information and/or data. The display (202) includes a text box (not shown) for displaying text on the computing device. That is, the display (202) is an interface configured to display a text box. The text box is a text input area for composing messages on the computing device, such as electronic mail messages, short messaging service (SMS) messages or text messages, etc. Text may include letters, numbers, punctuation, and/or symbols. Those skilled in the art will appreciate that the text box may also be used to display text for a user of the computing device, such as notifications/alerts, a greeting message, the current date/time, etc.

In one or more embodiments of the invention, the input interface (204) is configured to receive data and/or information from the user. The input interface (204) may be integrated into the display (202) as touch-screen functionality. The input interface (204) may also be integrated with the speaker(s) (206), described below, with voice-activated functionality. The input interface (204) may also be a keyboard to input text. The keyboard may be a wired keyboard, a wireless keyboard, a virtual keyboard, a keypad, or any other type of suitable input device that includes keys that are pressed to input data. The keyboard may be a full keyboard with all standard keys included, or may be a partially equipped keyboard that includes a subset of the keys typically included on a full keyboard. Further, the keyboard may be a QWERTY, English-based keyboard, a modified version of the QWERTY keyboard for international use (i.e., an English-international layout), or an extended keyboard with extended characters (i.e., an English-extended layout). Those skilled in the art will appreciate that the invention may also be implemented with foreign-language keyboards. The input interface (204) may also be a combination of a touch screen, voice activation, a keyboard, and/or any other type of interface for receiving data and/or information from the user.

The communication interface (205) may be an antenna, a serial port, a parallel port, a universal serial bus (USB) interface, or any type of data interface connection, such as Bluetooth® (Bluetooth is a registered trademark of Bluetooth SIG, Inc.), infrared signal, etc. Further, the communication interface (205) may also support Global System for Mobile (GSM) communications, and 3G and/or 4G standards for mobile phone communication. In one or more embodiments of the invention, the communication device (200) may be connected to a local area network (LAN) or a wide area network (e.g., the Internet) (not shown) via the communication interface (205). Further, the communication interface (205) may support both wired and wireless interfaces.

In one or more embodiments of the invention, the sound engine (222) is a sound generating module that is configured to play, using a speaker (206), audio files stored in the question files (216). The sound engine (222) may also be configured to receive sounds through a microphone (not shown) and create one or more audio files that are stored in the answer files (218). The sound engine (222) may further be configured to receive sounds through the microphone (not shown) where the sounds provide instruction for the communication device (200). The speaker(s) (206) may be integrated into the communication device (200). The speaker(s) (206) may also be an external device operatively connected to the communication device (200).

The computing device includes a processor (not shown) for executing applications and software instructions configured to perform various functionalities, and memory (not shown) for storing program instructions and application data. Software instructions to perform embodiments of the invention may be stored on any tangible computer readable medium such as a compact disc (CD), a diskette, a tape, a memory stick such as a jump drive or a flash memory drive, or any other computer or machine readable storage device that can be read and executed by the processor of the computing device.

The memory may be flash memory, a hard disk drive (HDD), persistent storage, random access memory (RAM), read-only memory (ROM), cache memory, an optical drive such as a compact disk (CD) drive or digital video disk (DVD) drive, any other type of suitable storage space, or any combination thereof. In one or more embodiments of the invention, the memory is configured to store a data structure that maps sound events to one or more keys on the keyboard of the computing device (discussed in detail below). In one or more embodiments of the invention, the memory is configured to store the localization components received through the network from the central server, as described in FIG. 1. In addition, the memory may be configured to store the aforementioned software instructions.

In one or more embodiments of the invention, the question/answer files (214) are stored on storage media and include question files (216) and answer files (218). Examples of a data structure stored in the question/answer files (214) include, but are not limited to, a data base, a spreadsheet, an extensible markup language (XML) document, and a plain text document. Examples of storage media used to store question/answer files (214) include, but are not limited to, flash memory, a hard disk drive (HDD), persistent storage, random access memory (RAM), read-only memory (ROM), any other type of suitable storage space, or any combination thereof. The storage media used to store question/answer files (214) may be the memory of the communication device (200). In one or more embodiments of the invention, the question/answer files (214) are updated based on content received from the central server of FIG. 1. The storage repository (214) may be distributed across multiple storage locations and/or different storage formats.

The question files (216) is configured to store potential questions. Questions may be inquiries, commands, statements, comments, and/or exclamations. The question files (216) may also be configured to store selected questions. More specifically, the question files (216) are configured to store a series of selected questions related to the condition of the subject to assist in evaluating the condition by the evaluation module (212), described below. The questions are stored in the question files (216) in multiple languages. The question files (216) may store the questions as audio files, text, video, video showing sign language, any other means of presentation of the questions, or any combination thereof.

In one or more embodiments of the invention, the answer files (218) is configured to store a list of potential answers for each question. In addition, the answer files (218) may be configured to store an answer received for each question that is answered. More specifically, the answer files (218) is configured to store a series of answers to questions related to the condition of the subject to assist in evaluating the condition by the evaluation module (212), described below. The answer(s) is stored in the answer files (218) in multiple languages. The answer files (218) may store the answer(s) as audio files, text, any other means of presentation of the answer(s), or any combination thereof.

In one or more embodiments of the invention, the evaluation module (212) is configured to evaluate a condition of the subject. The evaluation module (212) may perform an evaluation based on question(s) selected from the question files (216) and the corresponding answer(s) selected from the answer files (218). The evaluation of the evaluation module (212) may be presented in a number of formats, such as a text file, an output to the display (202), an audio file output through the speaker(s) (206), some other means of presenting the evaluation, or any combination thereof. The evaluation may be stored in the storage repository (214).

Further, those skilled in the art will appreciate that one or more elements of the aforementioned communication device (200) may be located at a remote location and connected to the other elements over a network. Further, embodiments of the invention may be implemented on a distributed system having a plurality of nodes, where each portion of the invention (e.g., question/answer files, evaluation module, display engine, input interface) may be located on a different node within the distributed system. In one embodiment of the invention, the node corresponds to a computer system. Alternatively, the node may correspond to a processor with associated physical memory. The node may alternatively correspond to a processor with shared memory and/or resources.

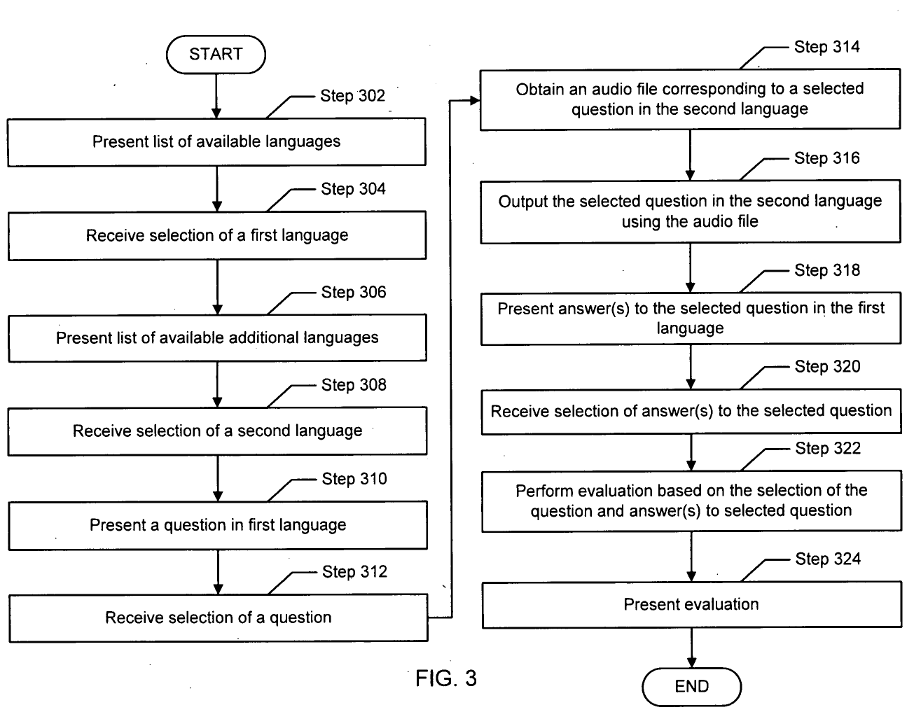

FIG. 3 shows a flowchart of a method for receiving information from a person speaking a second language in accordance with one or more embodiments of the invention. While the various steps in this flowchart are presented and described sequentially, one of ordinary skill will appreciate that some or all of the steps may be executed in different orders, may be combined or omitted, and some or all of the steps may be executed in parallel. In addition, a person of ordinary skill in the art will appreciate that other steps, omitted in FIG. 3, may be included in this flowchart. Accordingly, the specific arrangement of steps shown in FIG. 3 should not be construed as limiting the scope of the invention.

In Step 302, a list of available languages is presented. The list of available languages may be presented as text on a display, flags on a display, voice prompts announced over a speaker, some other form and/or method of presentation, or any combination thereof. In one or more embodiments of the invention, the available languages are the languages that are available for use in the method. In Step 304, the selection of the first language is received. The list of available languages presented in Step 302 may be accompanied by some means of selection. The first language may be selected, for example, by selecting text on a display, selecting a flag on a display, stating the name of the selected first language into a speaker, or by some other method of selection. When the first language is selected, the user may optionally be asked to verify that the selected first language is correct. In one or more embodiments of the invention, if the first language is not selected, then the first language is a default language.

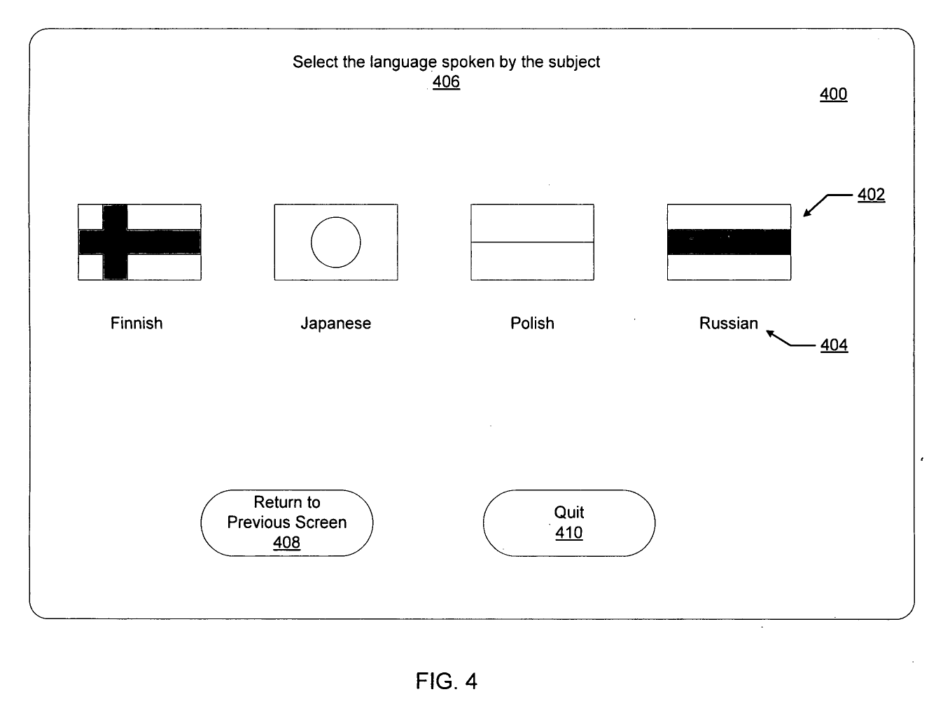

In Step 306, a list of available additional languages is presented. The list of available additional languages may be presented as text on a display, flags on a display, voice prompts announced over a speaker, some other form and/or method of presentation, or any combination thereof. In one or more embodiments of the invention, the available additional languages are the additional languages that are available for use in the method. In Step 308, the selection of the second language is received. The list of available additional languages presented in Step 306 may be accompanied by some means of selection. The second language may be selected, for example, by selecting text on a display, selecting a flag on a display, stating the name of the selected second language into a speaker, or by some other method of selection. When the second language is selected, the user may optionally be asked to verify that the selected second language is correct. In one or more embodiments of the invention, if the second language is not selected, then the second language is a default language. An example of selecting a second language is described in FIG. 4 below.

In Step 310, a question is presented in a first language. The question may be presented, for example, on a display, over a speaker, using another means , or any combination thereof. In one or more embodiments of the invention, the question is also presented in a second language, either simultaneously or consecutively with the presentation of the question in the first language. As explained above, questions may be inquiries, commands, statements, comments, and/or exclamations. A question may be one of a list or series of questions. For example, a list of first questions that may be presented on a display are: “What is your name?”, “Point to where you feel pain?”, and “On a scale of 1 to 10, how bad is your pain?”, and some commands that may be presented on the same display are: “Try to relax” and “I am here to help you, but I need you to answer a few questions first.” The question may be presented to the subject. Alternatively, the question may be presented to a third party. For example, the question is directed to a third person who is accompanying the subject where the subject may not be able to effectively communicate with the user. As another example, the third person is a parent accompanying his infant son, who is the subject.

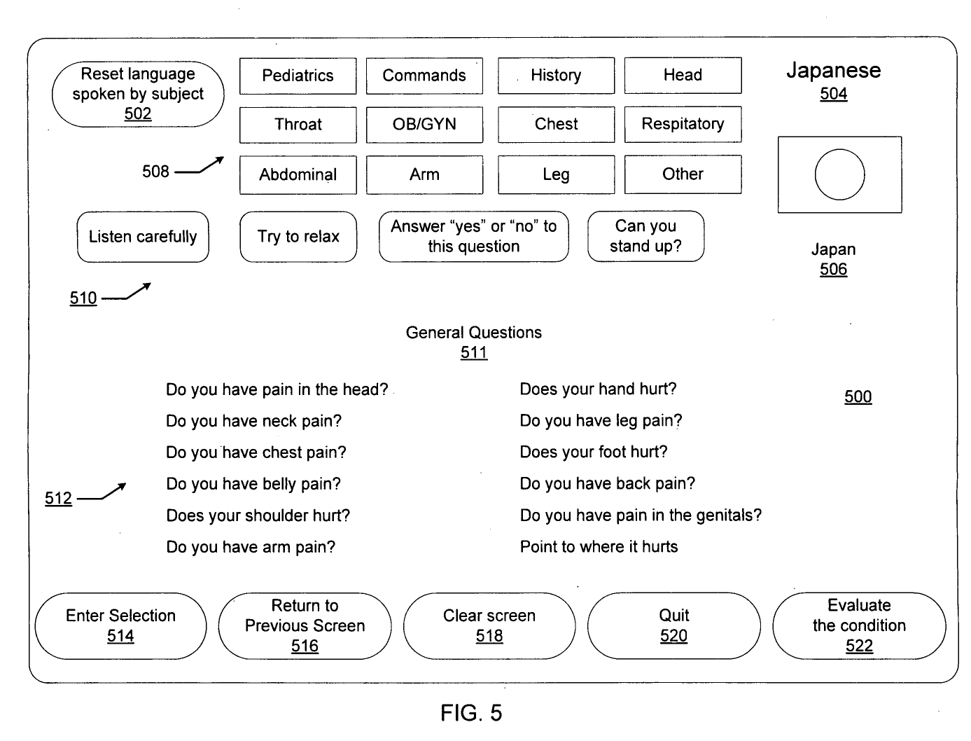

In Step 312, the selection of the question is received. Each selected question may be accompanied by a means of selection. For example, if shown on a display, each question may be adjacent to a pushbutton. Each question may also be a link which, when selected, prompts the corresponding next screen to be displayed. Alternatively, if output over a speaker, each question may be associated with a number, and a selection may be made by stating the number associated with the question that the user wants to ask the subject. An example of a display showing a list of first questions is described below in FIG. 5.

In Step 314, an audio file corresponding to the selected question in the second language is obtained. Alternatively, a video file corresponding to the selected question second language is obtained. A text file corresponding to the selected question in the second language may also be obtained. In Step 316, the audio file corresponding to the selected question in the second language is output. In one or more embodiments of the invention, the audio file is output using a multimedia device. The output of the audio file may use a speaker. The audio file corresponding to the question in the second language may also be presented on a display, some other means of output, or any combination thereof. In one or more embodiments of the invention, the audio file corresponding to the question is computer generated. The audio file corresponding to the question may also consist of a recording of a person native to speaking the second language. In one or more embodiments of the invention, the subject is deaf, and the selected question is presented in sign language using a display.

In Step 318, the answers to the selected question are presented. The answers to the selected question may be presented in a number of ways, including but not limited to orally through a speaker, in words using a display, using some other means of presenting answers, or any combination thereof. In one or more embodiments of the invention, the answers to the selected question are presented as an image of a human body. Further, the image of the human body may include a number of callouts where each callout is associated with a part of the human body.

The answers presented correspond to the question that was selected. For example, if the question that was selected was “Are you feeling any pain?”, then the answers that may be presented are “Yes,” “No,” and “I don't know.” As another example, if the question that was selected was “On a scale of 1 to 10, how bad is your pain?”, then the answers are presented in such a way as to allow a selection between the numbers of one and ten, inclusive. Specifically, there may be ten pushbuttons, one corresponding to each of the ten numbers as a potential answer. Alternatively, there may be ten checkboxes, one corresponding to each of the ten numbers as a potential answer.

Each answer to a question may be accompanied by a means of selection. The selection of an answer to a question may be presented in a number of ways, including, but not limited to, selecting a pushbutton associated with an answer, selecting a checkbox associated with an answer, free-form entry of an answer, selection from a list in a dropdown, verbally stating the response, some other means of selecting an answer, or any combination thereof. For example, if shown on a display, each potential response to a question may be adjacent to a pushbutton. Alternatively, if output over a speaker, each potential response may be associated with a number, and a selection may be made by stating the number associated with the answer that the user wants to choose in response to the selected question.

In Step 320, the selection to the answer to the selected question is received. In one or more embodiments of the invention, additional information may need to be obtained in order to evaluate a condition. In this scenario, a number of selected questions and corresponding answers may be considered in performing the evaluation. In this scenario, if more than one question is selected, then the process repeats itself, starting with Step 310, for the next selected question. If more than one question is selected, then subsequent questions may be presented based on the selection of the previous question(s) and the selection of the answer(s) to the previous selected question(s). More than one question may be selected for evaluation of the same condition. In addition, more than one question may be selected for evaluation of an additional condition associated with the subject. When more than one question is selected, the process continues to repeat itself until the evaluation is performed.

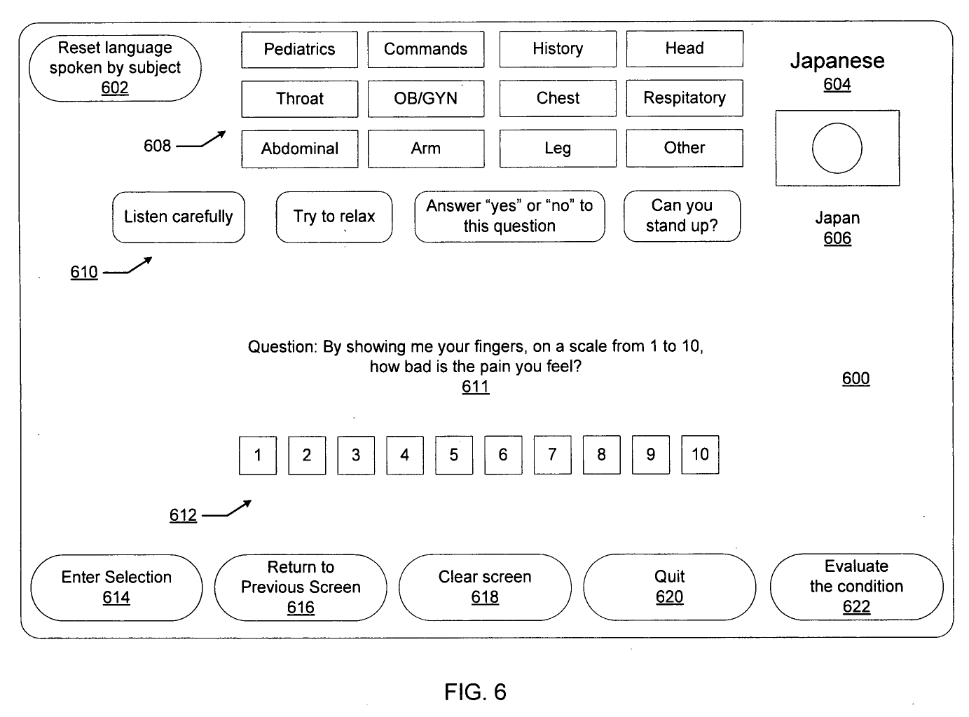

In Step 322, an evaluation, based on the selection of the question(s) and the selection of the answer(s) to the selected question(s), is performed. The evaluation may be performed at the request of the user, as described in FIGS. 5 and 6 below. The evaluation may also occur automatically based on the number of questions selected and answered, a protocol (as established, for example, by some government or regulatory authority) for asking questions to evaluate the condition, or some other basis of performing the evaluation.

In Step 324, the evaluation is presented. The evaluation may be in the form of text, a picture, a graph, an audio file, some other form of output, or any combination thereof. The evaluation may be presented in a number of ways, such as on a display, output using a speaker, printed on a printer, using some other means of presenting the evaluation, or any combination thereof.

FIGS. 4-6 show examples in accordance with one or more embodiments of the invention. The examples are not intended to limit the scope of the invention.

FIG. 4 shows an example of obtaining a second language in accordance with one or more embodiments of the invention. In this example, a display screen (400) displays a number of flags (e.g., 402), a name of country (e.g., 404), a screen heading (406), a return to previous screen option (408), and a quit option (410). Each flag (e.g., 402) represents the native language spoken in the country that the flag (e.g., 402) represents. Under each flag (e.g., 402) is the name of the country (e.g., 404) in the first language. In one or more embodiments of the invention, the name of the country (e.g., 404) may appear in other locations (e.g., above the flag (e.g., 402), transposed with the flag (e.g., 402), etc.) on the display (400). Also, in one or more embodiments, the name of the country (e.g., 404) may be listed on the display (400) in the language of that country, in addition to or in place of the name of the country (e.g., 404) in the first language. In addition, more than one screen on the display (400) may be used if the number of flags (e.g., 402) of countries with available second languages exceeds the available space on the display. Those skilled in the art will appreciate that a medium other than a display (such as, for example, voice interaction) may be used to obtain the second language. Other methods of selecting a second language may also be used.

To select a language in the example of FIG. 4, the flag (e.g., 402) of the country with the desired language is selected on the display (400). In one or more embodiments of the invention, the name of the country (e.g., 404) may also be selected. A language may be selected in other ways, such as by speaking the name of the country that is associated with the desired language. The display (400) in this example also includes a screen heading (406), located at the top center portion of the display (400) and displayed in the first language. The screen heading (406) in this example says, “Select the language spoken by the subject.” Those skilled in the art will appreciate that other words or phrases may be used for the screen heading (406). In addition, the screen heading (406) may be displayed in languages other than the first language.

The return to previous screen option (408) presents the same items that were presented on the immediately preceding presentation. Selecting the return to previous screen option (408) allows the user to return to the previous screen without starting the evaluation process over from the beginning. The quit option (410) starts the entire process of evaluating the condition at the beginning. More specifically, the quit option (410) erases all questions and answers selected in evaluating the condition. In one or more embodiments of the invention, selecting the quit option (410) is followed by presenting the user with the option to evaluate a new condition. Alternatively, the user may be presented with an option to power down the communication device after selecting the quit option (410). A similar presentation may be made for selecting a first language as in this example to select a second language. In one or more embodiments of the invention, the first language is selected before the second language is selected. In addition, the first and second languages may be selected prior to presenting a question related to the evaluation.

FIG. 5 shows an example of a question display screen in accordance with one or more embodiments of the invention. In this example a question display screen (500) displays: a reset second language option (502), a presentation of the second language (504), a presentation of the flag of the second language (506), a selection of general headings (508), a selection of general commands (510), a list of questions heading (511), a list of questions (512), an enter selection option (514), a return to previous screen option (516), a clear screen option (518), a quit option (520), and an evaluate the condition option (522). The reset second language option (502) resets the second language when selected. For example, if the reset second language option (502) is selected, a display as described in FIG. 4 may be presented. The wording of the reset second language option (502) may, as in this example, be stated in a way that the user recognizes. In one or more embodiments of the invention, the option to reset the second language may be presented in a number of different ways, such as a verbal command from the user (e.g., the user stating, “Change the language of the subject.”).

The presentation of the second language (504) presents the second language that is currently being used. In this example, the presentation of the second language (504) is presented in the first language as “Japanese.” In one or more embodiments of the invention, the presentation of the second language (504) is presented in the second language. Alternatively, the presentation of the second language (504) may be presented in both the first language and the second language.

The presentation of the flag of the second language (506) presents the flag of the country associated with the second language. In this example, the flag of Japan is presented. In one or more embodiments of the invention, the name of the country associated with the flag is also presented in proximity to the flag. In such a case, the name of the country associated with the flag may be presented in the first language and/or the second language. To capture regional differences in dialect within a country, a region of the country may also be listed. In cases where the second language presented in the presentation of the second language (504) is spoken in more than one country, the presentation of the flag of the second language (506) signifies that all questions are presented in the dialect spoken in the country associated with the flag and/or name of the second language presented in the presentation of the flag of the second language (506). In one or more embodiments of the invention, the flag and/or name of the second language presented in the presentation of the flag of the second language (506) may be modified, such as by selecting the flag on a display or issuing a verbal command.

The selection of general headings (508) presents a plurality of general topics that may be useful for the evaluation. The general topics listed in the selection of general headings (508) may include commands. The general topics listed in the selection of general headings (508) may also include a selection to allow for the questioning of a third party (e.g., a parent accompanying a child, a person that speaks in sign language accompanying a subject who is deaf or otherwise unable to hear). The general topics listed in the selection of general headings (508) may also include a selection for pediatrics. The general topics listed in the selection of general headings (508) may further include a selection for a history of the subject.

In one or more embodiments of the invention, the user selects one of the selection of general headings (508) to obtain a question associated with the selection in the list of questions (512), described below. In this example, the subject is a patient, and the selection of general headings (508) includes pediatrics, commands, history, head, throat, OB/GYN, chest, respiratory, abdominal, arm, leg, and other.

The list of general commands (510) presents a selection of commands that may be selected by the user at any time during the interaction with the subject. Each of the commands in the list of general commands (510) is presented in the first language. In one or more embodiments of the invention, each of the commands in the list of general commands (510) is also presented in the second language. One or more of the commands presented in the list of general commands (510) may change as appropriate based on the stage of the interaction between the user and the subject, based on the selection from the selection of general headings (508), and/or based on the list of questions (512) that is presented.

The list of commands (510) may contain commands, questions, and/or statements. In this example, the list of commands (510) includes: “Listen carefully,” “Try to relax,” “Answer Yes or No to each question,” and “Can you stand up?” Selecting one of the list of general commands (510) may be done in a number of ways, such as selecting a pushbutton on a display, as in this example. Once one of the commands from the list of commands (510) is selected, the selected command is presented to the subject in the second language. The selected command may be presented in the second language in a number of ways, including but not limited to using a recorded message of the command played over a speaker, presenting the command on a display, using some other method to present the command, or any combination thereof.

The list of questions heading (511) describes the questions contained in the list of questions (512). A list of questions heading (511) may be one of the selection of general headings (508). In this example, the list of questions heading (511) is “General questions.” The list of questions (512) presents a one or more questions and/or commands that the user may select. In one or more embodiments of the invention, each of the questions in the list of questions (512) is formulated in such a way that the user is able to understand the response to the question, even though the question is being asked in the second language. For example, a question is formulated such that the response to the question requires the subject to point to a part of his body, show a number of fingers corresponding to a number between 1 and 10, or respond with a “yes” or no.

Once one of the questions from the list of questions (512) is selected, the selected question is presented to the subject in the second language. The selected question may be presented in the second language in a number of ways, including but not limited to using a recorded message of the question played over a speaker and presenting the question on a display.

The enter selection option (514) saves a selection from the list of questions (512). When the enter selection option (514) is selected, the list of answers, as described in FIG. 6 below, that correspond to the selected question are presented. The return to previous screen option (516) presents the same items that were on the immediately preceding presentation. Selecting the return to previous screen option (516) allows the user to change and/or delete previous answers and/or questions in evaluating the condition without starting the evaluation process over from the beginning.

The clear screen option (518) maintains the current presentation of items, but any selections, additions, and/or deletions made on the screen are eliminated. More specifically, the clear screen option (518) reverts the presentation of items to the state it was in when the items on the screen were first presented. The selections, additions, and/or deletions that were made on the presentation (e.g., the current screen) prior to selecting the clear screen option (518) are not included in evaluating the condition. The quit option (520) starts the entire process of evaluating the condition at the beginning. More specifically, the quit option (520) erases all questions and answers previously selected in evaluating the condition. In one or more embodiments of the invention, selecting the quit option (520) is followed by asking the user if he wants to evaluate a new condition. Alternatively, the user may be asked if he wants to power down the communication device after selecting the quit option (520).

The evaluate the condition option (522) initiates an evaluation of the condition, based on the information that has been provided to that point for the subject. In one or more embodiments of the invention, after the evaluate the condition option (522) is selected, the user is asked if he wants to continue evaluating the condition. Alternatively, an option substantially similar to the quit option (520) may be presented after the evaluate the condition option (522) is selected.

FIG. 6 shows an example of an answer display screen in accordance with one or more embodiments of the invention. In this example, an answer display screen (600) displays: a reset second language option (602), a presentation of the second language (604), a presentation of the flag of the second language (606), a selection of general headings (608), a selection of general commands (610), a listing of the selected question (611), a list of answers (612), an enter selection option (614), a return to previous screen option (616), a clear screen option (618), a quit option (620), and an evaluate the condition option (622). An answer display screen is presented after the selection of a question, as described, for example, in FIG. 5 above.

The presentation of and description for the name of the reset second language option (602), the presentation of the second language (604), the presentation of the flag of the second language (606), the selection of general headings (608), the selection of general commands (610), the enter selection option (614), the return to previous screen option (616), the clear screen option (618), the quit option (620), and the evaluate the condition option (622) in this FIG. 6 are substantially similar to the description for the corresponding components described with respect FIG. 5 above.

In one or more embodiments of the invention, the listing of the selected question (611) presents the question that was selected on the previous screen and to which the list of answers (612) corresponds. In one or more embodiments of the invention, the list of answers (612) presents a number of potential answers that the user may select in response to the selected question. In one or more embodiments of the invention, each of the potential answers in the list of answers (612) is formulated in such a way that the potential answers are responsive to the selected question. For example, if the selected question is, “By showing me with your fingers, on a scale from one to ten, how bad is the pain you feel?” then ten potential answers (i.e., one for each number one through ten) appear in the list of answers (612) on the answer display screen (600). The potential answers in the list of answers (612) are presented in the first language. In one or more embodiments of the invention, the potential answers in the list of answers (612) are also presented in the second language. The potential answers in the list of answers (612) may be presented in a number of ways, including but not limited to using a recorded message of the potential answers played over a speaker, including an ability to provide an answer using voice response, and presenting the potential answers on a display.

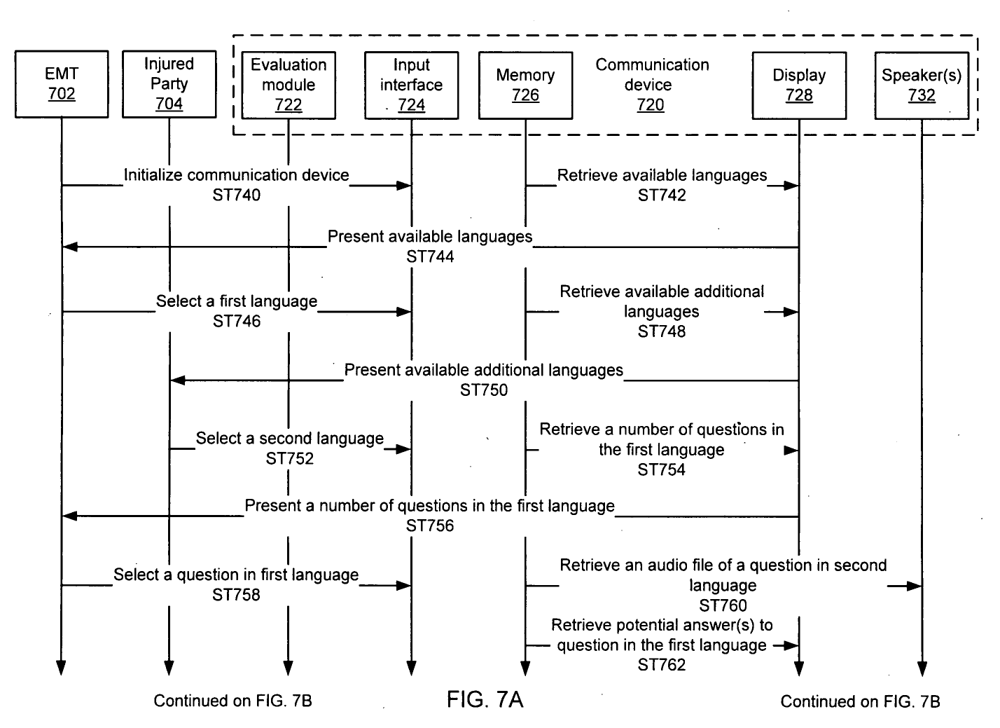

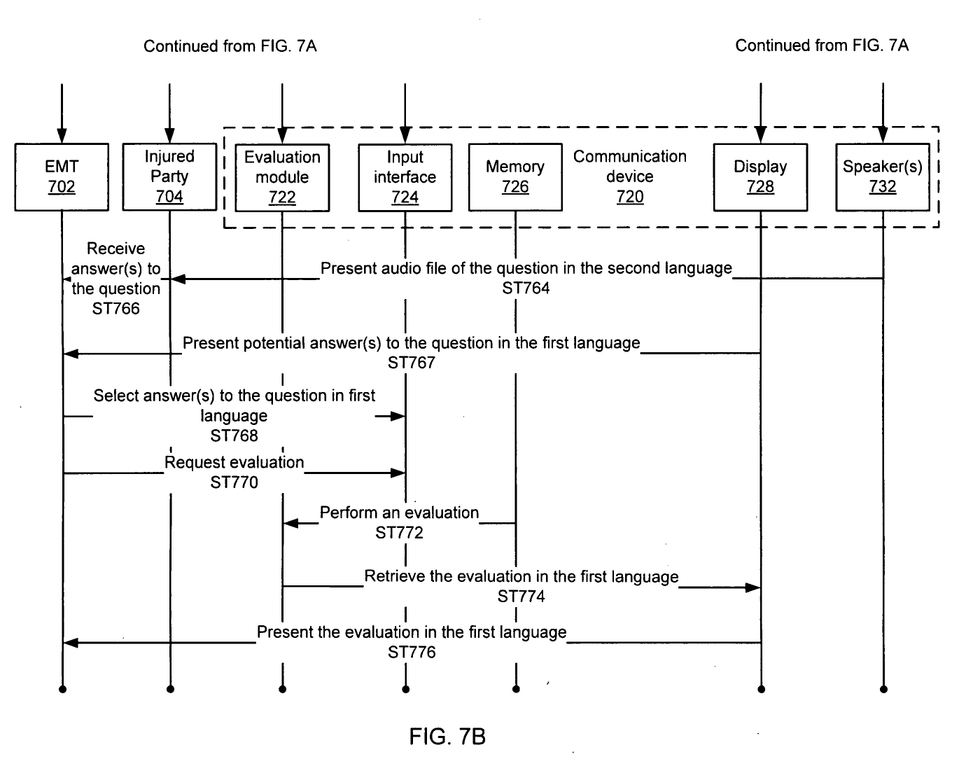

FIGS. 7A and 7B illustrate various examples being performed by a system in which one or more embodiments of evaluating a condition associated with a person may be implemented. More specifically, FIGS. 7A and 7B depict through a sequence diagram (700) a use of an EMT (702), an injured party (704), and the communication device (720), which includes an evaluation module (722), an input interface (724), a processor (not shown), a display engine (not shown), a display (728), a sound engine (not shown), and speaker(s) (732). While the following example is specific to an implementation involving the communication device (720), this example should not be deemed as limiting evaluating a condition associated with a person to this particular example.

Consider a scenario where the EMT (702) (i.e., first person) is an emergency medical technician, and the injured party (704) (i.e., second person) is a person who has suffered some injury and requires immediate medical attention. The EMT in this example speaks a different language than the injured party, and the EMT uses a hand-held communication device (720), in accordance with one or more embodiments of the invention, to help determine the condition for which the injured party requires treatment.

Beginning with FIG. 7A, at Step 740, the EMT (702) initializes the communication device (720) by selecting the proper portion of the input interface (724). At Step 742, the available languages are retrieved from memory (726) and displayed along with a request for the first language (i.e., the language spoken by the EMT) using the display (728). The available languages may be presented in such a manner that the EMT (702) recognizes the available languages. At Step 744, the display (728) presents the available languages to the EMT (702). At Step 746, the EMT (702) selects the first language using the input interface (724).

At Step 748, the available additional languages are retrieved from memory (726). At Step 750, the display (728) presents the available additional languages to the injured party (704), along with a request for the second language (i.e., the language spoken by the injured party). At Step 752, the injured party (704) selects the second language using the input interface (724).

At Step 754, a number of textual question files is retrieved from the question/answer files (not shown) using the memory (726), where each of the textual question files is in the first language. At Step 756, the number of questions are presented on the display (728) to the EMT (702) in the first language. At Step 758, the EMT (702) selects one of the number of questions using the input interface (724). At Step 760, an audio file is retrieved from the question/answer files using the memory (726), where the audio file is in the second language and corresponds to the selected question. At Step 762, the potential answers to the selected question are retrieved from the question/answer files using the memory (726).

Referring to FIG. 7B, at Step 764, the speaker(s) (732) output the selected question to the injured party (704) in the second language. At Step 766, the injured party (704) answers the question, which is witnessed by the EMT (702). At Step 767, the display engine presents the potential answers to the selected question using the display (728). At Step 768, the EMT (702) uses the input interface (724) to select the answer from the potential answers to the selected question, as given by the injured party (704).

At Step 770, the EMT (702) uses the input interface (724) to ask for an evaluation of the injured party (704). At Step 772, the evaluation module (722) to performs an evaluation of the condition of the injured party (704) based on the selected question and the answer to the selected question, as stored in the memory (726). At Step 774, the evaluation generated by the evaluation module (722) is sent to the display engine to present the evaluation on the display (728). Finally, at Step 776, the EMT (702) receives the evaluation of the condition of the injured party (704) from the display (728).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer readable medium comprising computer executable instructions for evaluating a condition associated with a first person, the instructions comprising functionality to:
present a first question in a first language to a user;
receive a selection of the first question from the user;
obtain a first audio file corresponding to the first question in a second language, wherein the first person communicates in the second language;
output, in auditory form, the first question in the second language using the first audio file;
present a first plurality of answers to the first question to the user, wherein the first plurality of answers is in the first language;
receive a selection of one of the first plurality of answers from the user based on a response to the first question by the first person;
perform an evaluation of the condition associated with the first person based on the selection of the first question and the selection of the one of the first plurality of answers; and
present the evaluation to the user.

2. The computer readable medium of claim 1, further comprising instructions comprising functionality to:
prior to performing the evaluation:
present a second question in the first language to the user, wherein the second question is selected from a second plurality of questions based on the selection of the one of the first plurality of answers;
receive a selection of the second question from the user;
obtain a second audio file corresponding to the second question in the second language;
output the second question in the second language in auditory form using the second audio file to the first person;
present a second plurality of answers to the second question to the user, wherein the second plurality of answers is in the first language; and
receive a selection of one of the second plurality of answers from the user based on a response to the first question by the first person, wherein performing the evaluation is further based on the selection of the second question and the selection of the one of the second plurality of answers.

3. The computer readable medium of claim 1, further comprising instructions comprising functionality to:
receive a selection of the first language from a plurality of languages from the user.

4. The computer readable medium of claim 3, further comprising instructions comprising functionality to:
receive a selection of the second language from the plurality of languages.

5. The computer readable medium of claim 4, wherein, prior to receiving the selection of the second language, presenting a name of the second language in the first language and the second language.

6. The computer readable medium of claim 4, wherein, prior to receiving the selection of the second language, presenting a flag of a country for which the second language is associated.

7. The computer readable medium of claim 1, further comprising instructions comprising functionality to:
verify, before presenting the first question, that the first person communicates in the second language.

8. The computer readable medium of claim 1, wherein the first plurality of answers comprises at least one selected from a group consisting of answering in the affirmative, answering in the negative, indicating a location, and indicating a number.

9. The computer readable medium of claim 1, wherein presenting the first plurality of answers comprises presenting a plurality of images corresponding to the first plurality of answers, and wherein the plurality of images comprises at least one selected from a group consisting of an image of a human body, a plurality of pushbuttons, a plurality of radio buttons, a plurality of checkboxes, and a list from a dropdown box.

10. The computer readable medium of claim 1, wherein presenting the first plurality of answers comprises presenting a plurality of images corresponding to the first plurality of answers, the plurality of images comprising an image of a human body with a plurality of callouts, each of the plurality of callouts corresponding to a part of the image of the human body.

11. A method for evaluating a condition associated with a first person, comprising:
presenting a first question in a first language to a user;
receiving a selection of the first question from the user;
obtaining a first audio file corresponding to the first question in a second language;
outputting, in auditory form, the first question in the second language using the first audio file;
presenting a first plurality of answers to the first question to the user, wherein the first plurality of answers is in the first language;
receiving a selection of one of the first plurality of answers from the user based on a response to the first question by the first person;
performing an evaluation of the condition associated with the first person based on the selection of the first question and the selection of the one of the first plurality of answers; and
presenting the evaluation to the user.

12. The method of claim 11, further comprising:
prior to performing the evaluation:
presenting a second question in the first language to the user, wherein the second question is selected from a second plurality of questions based on the selection of the one of the first plurality of answers;
receiving a selection of the second question from the user;
obtaining a second audio file corresponding to the second question in the second language;
outputting the second question in the second language in auditory form using the second audio file to the first person;
presenting a second plurality of answers to the second question, wherein the second plurality of answers is in the first language; and
receiving a selection of one of the second plurality of answers from the user based on a response to the first question by the first person, wherein performing the evaluation is further based on the selection of the second question and the selection of the one of the second plurality of answers.

13. The method of claim 11, wherein the first person has a medical condition that requires immediate treatment.

14. The method of claim 11, wherein the first person is a traveler at a location that facilitates international travel.

15. The method of claim 11, wherein the first question is presented based on a protocol created by at least one of a group consisting of an ambulance service, a government authority, a regulatory entity, and a professional group.

16. The method of claim 11, further comprising:
verifying, before presenting the first question, that the first person communicates in the second language.

17. A communication device for evaluating a condition associated with a first person for a user, comprising:
a processor;
a speaker configured to output sounds;
a storage repository;
a memory comprising software instructions which, when executed by the processor, enable the communication device to:
present a first question in a first language on a display device to a user;
receive a selection to the first question from the user;
obtain from the storage repository a first audio file corresponding to the first question in the second language;
output the first question in the second language using the speaker and the first audio file;
present a first plurality of answers to the first question to the user, wherein the first plurality of answers is in the first language;
receive a selection of one of the first plurality of answers from the user based on a response to the first question by the first person;
perform an evaluation of the condition associated with the first person based on the selection of the first question and the one of the first plurality of answers;
present the evaluation to the user using the display device; and
store the evaluation in the storage repository.

18. The communication device of claim 17, wherein the memory further comprises instructions, which when executed by the processor, enable the communication device to:
present a second question in the first language on the display device to the user, wherein the second question is selected from a second plurality of questions based on the selection of the one of the first plurality of answers;
receive a selection of the second question from the user;
obtain from the storage repository a second audio file corresponding to the second question in the second language;
output the second question in the second language using the speaker and the second audio file;
present a second plurality of answers to the second question to the user, wherein the second plurality of answers is in the first language; and
receive a selection of one of the second plurality of answers from the user based on a response to the first question by the first person, wherein performing the evaluation is further based on the selection of the second question and the selection of the one of the second plurality of answers.

19. The communication device of claim 17, wherein the first question is presented based on a protocol created by at least one of a group consisting of an ambulance service, a government authority, a regulatory entity, and a professional group.

20. The communication device of claim 17, wherein the memory further comprises instructions, which when executed by the processor, enable the communication device to:
verify, before presenting the first question, that the first person communicates in the second language.
